(19) United States
(12) Patent Application Publication
(10) Pub. No.: US 2024/0368783 A1
(43) Pub. Date: Nov. 7, 2024

(54) ELECTROLYZER ELECTROCATALYST COMPRISING COBALT (CO) OXIDE, ZIRCONIUM (ZR) AND A NOBLE METAL, AN ELECTRODE COMPRISING THE ELECTROCATALYST AND THE USE OF THE ELECTROCATALYST IN AN ELECTROLYSIS PROCESS

(71) Applicant: Magneto Special Anodes B.V., Schiedam (NL)

(72) Inventor: Johannes Godfried VOS, Leiden (NL)

(73) Assignee: Magneto Special Anodes B.V., Schiedam (NL)

(21) Appl. No.: 18/691,488

(22) PCT Filed: Sep. 13, 2022
(86) PCT No.: PCT/EP2022/075440

§ 371 Date: Mar. 13, 2024

Related U.S. Application Data
(60) Provisional application No. 63/243,353, filed on Sep. 13, 2021.

(51) Int. Cl. C25B 11/093; C25B 1/04; C25B 11/063

(52) U.S. Cl. CPC C25B 11/093; C25B 1/04; C25B 11/063

(57) ABSTRACT

An electrolyzer electrocatalyst, comprising Cobalt (Co) oxide, Zirconium (Zr) and a noble metal, an electrode for use in an electrolyzer, the electrode comprising a support and a coating comprising said electrocatalyst, an electrochemical system comprising an electrolyser, the electrolyser having an electrode comprising said electrocatalyst, the use of said electrocatalyst for catalysing an electrolysis process, a method for electrolysing water using said electrocatalyst and a method for producing an electrode comprising said electrocatalyst.

Electrolysis is a promising option for carbon-free hydrogen production from renewable and nuclear resources. Electrolysis is the process of using electricity to split water into hydrogen and oxygen. The process of electrolysis is performed in a unit called an electrolyzer. Electrolyzers can range in size from small, appliance-size equipment that is well-suited for small-scale distributed hydrogen production, to large-scale, central production facilities that, for instance, could be directly connected to renewable or other non-greenhouse-gas-emitting forms of electricity production.

### BACKGROUND OF THE TECHNOLOGY

In 2021, the U.S. Department of Energy's (DOE's) has formulated an objective to reduce the costs of clean hydrogen by 80% to $1 per 1 kilogram in 1 decade. The objective of reducing the production of hydrogen to $1 per 1 kilogram in 1 decade is referred to as the hydrogen “1 1 1” initiative. Electrolysis is a leading hydrogen production pathway to achieve this goal.

Hydrogen produced via electrolysis can result in zero greenhouse gas emissions, depending on the source of the electricity used. The source of the required electricity, including its cost and efficiency, as well as emissions resulting from electricity generation, must be considered when evaluating the benefits and economic viability of hydrogen production via electrolysis. In many regions in the world, today's power grid is not ideal for providing the electricity required for electrolysis. The reason for this is the greenhouse gases released during the actual production of the electricity and the amount of fuel required to produce electricity due to the low efficiency of the electricity generation process.

Hydrogen production via electrolysis is being pursued for renewable and nuclear energy options, including wind, solar, hydro and geothermal energy production. These pathways result in virtually zero greenhouse gas and criteria pollutant emissions, provided the electricity that is used for electrolysis is obtained by means of renewable energy sources. Moreover, it is important that the overall production cost for the energy decrease significantly to be competitive with more mature carbon-based pathways such as natural gas reforming.

In view of the above, there is a growing need for improved electrolyzers which show improved energy efficiency and lifetime. In particular, there appears to be a need for providing improved coatings for electrodes used in electrolyzers, such as improved coatings directed to oxygen evolution as target reaction.

### SUMMARY OF THE INVENTION

According to a first aspect, the disclosure relates to an electrolyzer electrocatalyst, comprising Cobalt (Co) oxide, Zirconium (Zr) and a noble metal.

According to a second aspect, the disclosure relates to an electrode for use in an electrolyzer, the electrode comprising a support and a coating, wherein the coating comprises Cobalt (Co) oxide, Zirconium (Zr) and a noble metal.

According to a third aspect, the disclosure relates to an electrochemical system comprising an electrolyser, the electrolyser having a cathode, an anode, and an electrolyte or electrolytes, wherein the cathode, the anode or both the cathode and the anode comprise an electrocatalyst, the electrocatalyst comprising Cobalt (Co) oxide, Zirconium (Zr) and a noble metal.

According to a fourth aspect, the disclosure relates to the use of an electrocatalyst for catalysing an electrolysis process, wherein the electrocatalyst comprises Cobalt (Co) oxide, Zirconium (Zr) and a noble metal.

According to a fifth aspect, the disclosure relates to a method for electrolysing water comprising the steps of:
(i) providing a water electrolyser comprising an anode, a cathode, and an electrolyte or electrolytes, wherein at least one of the anode and the cathode comprises an electrocatalyst comprising Cobalt (Co) oxide, Zirconium (Zr) and a noble metal;
(ii) contacting the water electrolyser with water;
(iii) creating an electrical bias between the cathode and the anode; and
(iv) generating hydrogen and/or oxygen.

According to a sixth aspect, the invention relates to the use of a cathode electrocatalyst comprising Cobalt (Co) oxide, Zirconium (Zr) and a noble metal for producing hydrogen via an electrolysis process.

According to a seventh aspect, the disclosure relates to a method for producing an electrode for use in an electrolyzer, the electrode comprising a support and a coating, the method comprising the steps of:
preparing a metal support comprising Nickel (Ni) or Titanium (Ti),
applying on the support a coating comprising Cobalt (Co), Zirconium (Zr) and a noble metal, and
heating the support comprising the coating in air.

### BRIEF DESCRIPTION OF THE DRAWINGS

FIG. 1 shows an exemplary embodiment of an electrolyzer 10 according to the prior art;

FIG. 2 illustrates the effect of adding Zirconium and Ruthenium to a Cobalt-oxide coating on the initial potential (Eᵢ) of a coated electrode;

FIG. 3 provides a comparison between the lifetime of a Cobalt oxide coating, shown in units of total electrical charge passed per surface area (kAh/m²) before coating deactivation, and the Cobalt loading in the coating;

FIGS. 4a and 4b illustrate respectively the lifetime and the initial potentials of Cobalt oxide coatings with a fixed Cobalt/Ruthenium mass ratio and varying Zirconium mass fractions;

FIGS. 5a and 5b illustrate the relationship between the lifetime and initial potential of Cobalt oxide coatings with a fixed Cobalt/Zirconium ratio and an increasing Ruthenium loading;

FIG. 6a shows the results of short-term electrolysis experiments run at 10 kA/m² for a Nickel plate and respectively a Titanium support and a Nickel support comprising a Cobalt/Zirconium/Ruthenium coating;

FIG. 6b show the relative wear rates of Cobalt and Zirconium measured on a Co/Zr/Ru coating on a Titanium support;

FIG. 7 shows the result of measurements in KOH 30% at a temperature of 20° C. with a Nickel plate and a Nickel support electrode and a Titanium support electrode both provided with a Co—Zr/Ru coating 100-9/1;

FIG. 8 represent the results of tests that were run to assess the effect of using a Cobalt oxide coating comprising Zirconium as dispersing agent and Gold (Au) to promote electrical conductivity throughout the bulk coating; and

FIG. 9 represent the results of tests that were run to assess the effect of using a Cobalt oxide coating comprising Au in terms of activity.

### DETAILED DESCRIPTION OF THE INVENTION

The phraseology and terminology used in this disclosure is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. The use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Hydrogen (H₂) is an important feedstock for various branches of the chemical industry, such as petrochemicals and semiconductor manufacturing. Moreover, it holds high potential as an agent to make the global energy infrastructure more environmentally sustainable. Hydrogen can serve as energy carrier to replace fossil fuels in a hydrogen economy, and it is also able to reduce CO₂ emissions in energy-intensive applications such as steel and aluminium refining.

The most prominent way of producing hydrogen that is truly ‘green’ is through water electrolysis powered by renewable energy sources. However, water electrolysis suffers from energy inefficiencies due to the difficulty of catalyzing the reaction.

Better electrocatalysts are needed to make the process more economically competitive.

The overall reaction in water electrolysis is given by

2H₂O→2H₂+O₂

The process is carried out in either acid or alkaline electrolyzers, where acid electrolyzers use a wet acidic ion exchange membrane as electrolyte, and alkaline electrolyzers use concentrated aqueous base, typically KOH in range of 15-30% mass, as electrolyte with a Zirfon separator.

Acidic systems benefit from compactness, low electrolyte resistance and good gas separation capabilities, which allows them to run at higher current densities of typically 10-30 kA/m2, and makes them more flexible in terms of ramping activity up and down. One of the main disadvantages is the reliance of this type of electrolyzer on iridium as electrocatalyst on the anode, which is an exceedingly rare and therefore expensive element. Alkaline systems rely much less on critical materials, but are bulkier, have higher internal resistances and lower power flexibility.

The overall reaction consists of two electrochemical half reactions, the hydrogen evolution reaction (HER) and oxygen evolution reaction (OER), which are described respectively in acidic and alkaline electrolytes by

4H⁺⁺4e⁻→2H₂

4H₂O+4e⁻→2H₂+4OH⁻

2H₂O→O₂+4H⁺+4e⁻

4OH⁻→O₂+2H₂O+4e⁻

The largest energy loss originates from the oxygen-evolving anodic half-reaction. A better electrocatalyst for this reaction would have a smaller overpotential and higher energy efficiency. In this disclosure an electrode comprising an improved electrocatalyst is presented.

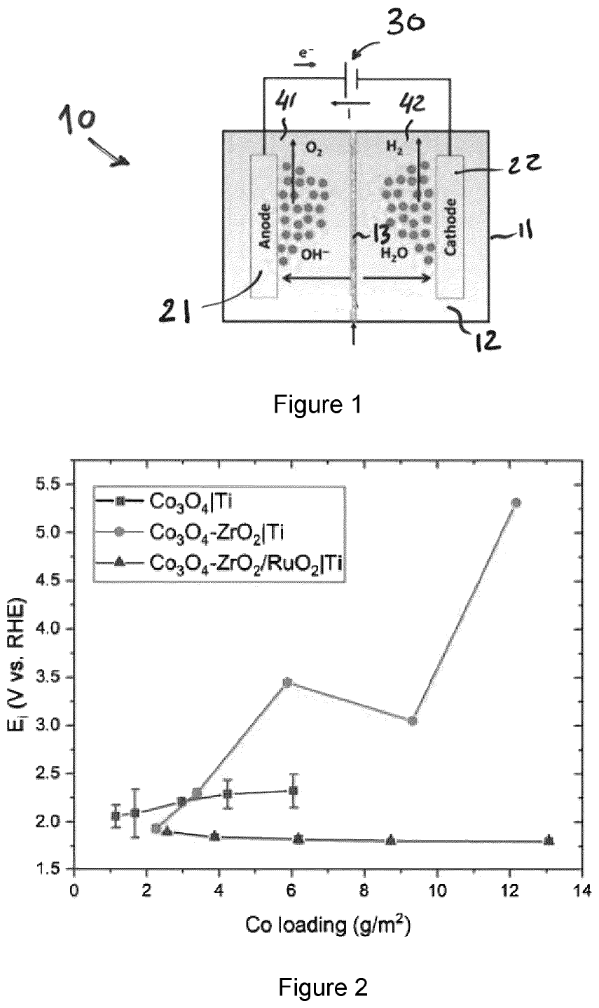

FIG. 1 shows an exemplary embodiment of an electrolyzer 10 to explain the basic principle of electrolysis. The electrolyzer 10 comprises a container 11 with a liquid alkaline solution of sodium or potassium hydroxide as the electrolyte 12.

The electrolyzer 10 further comprises an anode 21 and a cathode 22 which are placed in the electrolyte 12. The anode 21 and the cathode 22 are connected to a source of electrical energy 30. In the electrolyzer 10, a diaphragm 13 is positioned in between the anode 21 and the cathode 22.

As indicated in FIG. 1, in general, alkaline electrolyzers operate via transport of hydroxide ions (OH⁻) through the electrolyte from the cathode 22 to the anode 21. The evolution of oxygen at the anode 21 side is indicated with reference number 41. The generation of hydrogen on the cathode 22 side is indicated with reference number 42.

Electrolyzers using a liquid alkaline solution of sodium or potassium hydroxide as the electrolyte have been commercially available for many years. One important parameter of alkaline hydrolysis is the type of electrodes and coatings that are used. Evolution of oxygen in alkaline water electrolyzers is usually catalyzed on anodes made with massive nickel, massive steel, or nickel coated steel. While these materials offer long lifetimes, the overpotential for oxygen evolution is relatively high. One of the effects thereof is a relatively high level of corrosion, for instance for steel-based anodes. The specific circumstances of this corrosion are not well-understood at the moment. In view of corrosion prevention, the anodes 21 and cathodes 22 used in electrolyzers 10, normally comprise an adapted coating to improve the lifetime of the electrodes.

In the prior art alternative solutions for producing electrolyzers are known, which use solid alkaline exchange membranes (AEM) as the electrolyte. This anion exchange membrane can be used with pure water or a KOH solution as additional electrolyte. These alternative solutions using an anion exchange membrane to separate anode and cathode compartments are showing promise on laboratory scale.

The present disclosure relates to an electrocatalyst which is used in the form of a coating for an electrode, in particular an anode 21, which can improve the properties of the electrode and in particular the lifetime of the electrode. The coating according to the disclosure is directed to oxygen evolution as target reaction. The coating is a Cobalt (Co) oxide based coating comprising Zirconium (Zr) as dispersing agent and a noble metal to promote electrical conductivity throughout the bulk coating. According to the disclosure, the noble metal is preferably selected from Ruthenium (Ru), Gold (Au), Iridium (Ir), Platinum (Pt) and Palladium (Pd). It has been established, as described in more detail below, that the lifetime of the coating comprising Cobalt oxygen, Zirkonium and in particular Ruthenium and/or Gold is much higher than known coatings. The coating described in the disclosure provides longer lifetimes than other well-known Ni substitutes, such as Ni—Fe oxyhydroxides, due to the much higher robustness of cobalt oxide.

In one embodiment, an anode comprising a Cobalt oxide coating comprising Zr and Ru and/or Au allows for catalyzing oxygen evolution at a lower overpotential due to the relatively high electrochemical activity of Cobalt, and benefits from the incorporation of Zr as a dispersing agent and Ru and/or Au to promote electrical conductivity throughout the bulk coating.

According to the disclosure, the mentioned coating comprising the Cobalt oxygen, Zirconium and a noble metal such as Ruthenium or Gold is deposited on an adapted metal support. Preferably, the coating is deposited on a Titanium (Ti) or Nickel (Ni) support. Alternatively, the support comprises a Titanium alloy, a Nickel alloy, steel or stainless steel.

Titanium is an especially attractive substrate, due to its dimensional stability and high availability. A known drawback of using Titanium as a support material for obtaining an electrode, is the possibility of forming an electrically insulating oxide interlayer during the coating preparation or actual electrolysis. However, according to present disclosure, the risk of forming such an electrically insulating oxide interlayer is negated by the presence of Ru in the coating, which has the ability to form a passivation-resistant interlayer at the interface Titanium-coating.

Nickel is particularly suitable for the preparation of electrodes since it is dimensionally stable and is capable of strongly interacting with Co by forming NiCo₂O₄ spinels.

Cobalt oxide (Co₃O₄) is a well-known oxygen evolution electrocatalyst and, along with mixtures of nickel iron oxides and cobalt iron oxides, one of the materials with the highest power efficiency. This means that the material allows in use for a low overpotential. The material has a lower overpotential than nickel oxide grown on massive Ni, which is the standard material in alkaline electrolyzers today, and which tends to deactivate over time.

To utilize Co₃O₄ layers in alkaline electrolyzers, significant layer thicknesses need to be deposited; although it was found that the cobalt wear rate during operation is on the same scale as iridium oxide, a state-of-the-art electrocatalyst with very high rarity and price, the extremely high lifetime requirements of alkaline electrolyzers necessitate significant loadings. Co₃O₄ however suffers from poor bulk electrical conductivity, which makes thick layers of the pre-formed oxides unfeasible.

In one embodiment, attempts to circumvent this issue are achieved by adding to the Co₃O₄ layer both a) Zr and b) Ru or Au, which serve as a) a dispersing agent to increase the volume and active surface area of the electrocatalyst, and b) a conductivity agent, to improve the electrical conductivity in the bulk coating and prevent the formation of a passivating layer at the interface of the coating and the massive metal support during repeated calcination in air and electrolytic operation of the coating.

According to the disclosure it has been established that, surprisingly, very small amounts of Zirconium in combination with a very small amount of a noble metal, such as Ruthenium or Gold importantly alters and improves the properties of a coating comprising Cobalt oxide comprising coating, in particular when considering oxygen evolution.

It is noted that the coatings according to the disclosure allow electrolyzers using electrodes and in particular anodes provided with the coating to operate at a higher power efficiency. The power efficiency is the key factor in determining the OPEX, which term refers to the operating expenses. If the gain in efficiency at high currents densities is sufficient, it may also reduce the needed stack size, which decreases the CAPEX, which term refers to the capital expenses.

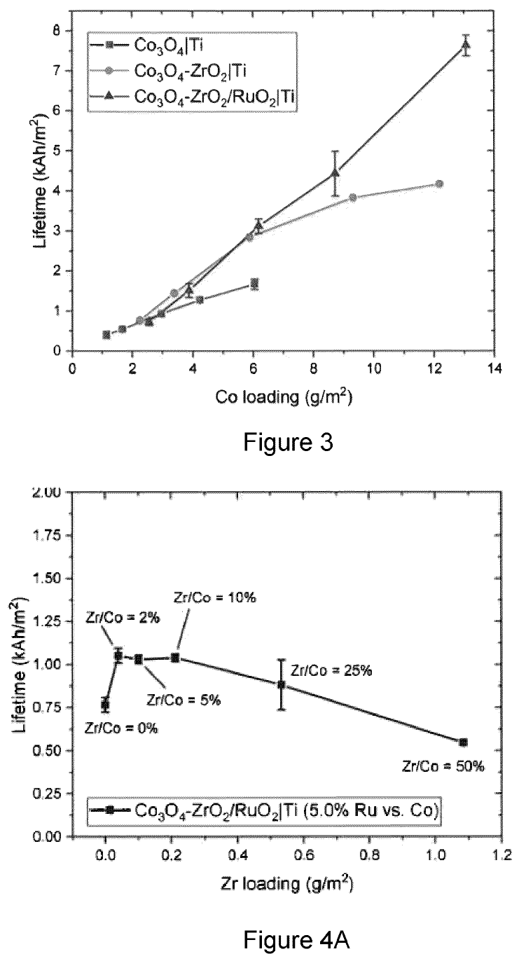

FIGS. 2 and 3 illustrate the beneficial effects of the inclusion of Zirconium and Ruthenium in Cobalt oxide on oxygen evolution electrocatalysis.

FIG. 2 illustrates the effect of adding Zirconium and Ruthenium to Cobalt-oxide coatings on the initial potential (E), which is shown on the Y-axis. On the X-axis the Cobalt loading of the coating is indicated. FIG. 2 relates to the application of an Cobalt oxide coating on a Titanium support.

FIG. 2 firstly shows the relationship between Cobalt loading of pure Co₃O₄ deposited on a Titanium support and the initial potential (E). As shown in FIG. 2, pure Co₃O₄ deposited on Titanium sees a gradual rise of the electrode potential as a function of Cobalt loading.

As further shown in FIG. 2, the addition of only Zirconium lowers the electrode potential at low Cobalt loadings but leads to a sharp rise in potential with increasing Cobalt loading. FIG. 2 clearly shows that the addition of a small amount of Ruthenium in addition to Zirconium significantly lowers the electrode potential over the full range of low Cobalt loadings to higher Cobalt loadings.

In the example of FIG. 2, the presence Ruthenium is in the order of 5% mass relative to Cobalt. This means that for each gram of Cobalt in the coating 0.05 gram Ruthenium is present. In view of the price of Ruthenium, it is important to note that very small quantities already show a beneficial effect on the properties of the coating.

FIG. 3 provides a comparison between on the Y-axis the lifetime of a Cobalt oxide coating, shown in units of total electrical charge passed per surface area (kAh/m²) before coating deactivation, and on the X-axis the Cobalt loading in the coating.

FIG. 3 shows the effect of adding Zirconium to the coating and the effect of adding both Zirconium and Ruthenium to the coating. FIG. 3 refers to the application of a Cobalt oxide coating applied on a Titanium support.

According to FIG. 3, a coating of pure Co₃O₄ deposited on Titanium shows a linear increase of the lifetime of the coating as a function of Cobalt loading. FIG. 3 further shows that the addition of Zirconium has a beneficial effect on the lifetime of the coating and at low Cobalt loadings the addition of Zirconium clearly increases the lifetime. The Zirconium containing coating shows a linear trend in the increase of the lifetime related to the increasing Cobalt loading, but the beneficial effect wears off at higher Cobalt loadings.

FIG. 3 finally shows that the further addition of Ruthenium leads to an increase of the lifetime of the coating at lower Cobalt leadings comparable to the coating only comprising Zirconium. However, the coating comprising both Zirconium and Ruthenium shows a continuing and linear increase of the lifetime with an increasing Cobalt loading. In the example of FIG. 3, a small amount of Ruthenium, in the order of 5% mass relative to Cobalt, is used to obtain the shown beneficial effect. As shown, the Ruthenium containing coating has similar effect at lower Cobalt loading as the coating only comprising Zirconium, but the effect is no longer limited to lower Cobalt loadings.

It is noted that the results shown in FIGS. 2 and 3 were obtained using electrodes with Cobalt oxide coatings that were formed by spin-coating water-based solutions of the metal salt precursors onto Titanium supports. These Titanium supports were in advance etched in hydrochloric (HCl) acid.

In general, the coating can be painted on the support. According to an embodiment, prior to the step of applying the coating, a viscosity modifier is added. An adapted viscosity modifier for use in the production of electrodes according to the disclosure is polyethylene glycol.

After the application of the coating on the support, the production process was followed by thermal decomposition at 400° C. for 15 minutes in air. That means that the Titanium supports were heated in an oven. The mentioned step of heating could be done be a temperature between about 300° C. and 600° C., preferably by a temperature between about 350° C. and 450° C.

The metal salt referred above could, for instance, comprise CoCl₂, RuCl₃, and ZrCl₂. Alternatively, the salts could comprise Co(NO₃)₂, Zr(NO₃)₂ and Ru(No)(NO₃).

The so obtained electrodes were then electrolyzed at 600 A/m² in strong acid (H₂SO₄; 25%). Although the coatings are intended to be used under strongly alkaline conditions, electrolysis in strong acid serves as an accelerated lifetime test, since one of the primary degradation mechanisms is local acidification at the catalyst surface due to the nature of oxygen evolution reaction.

The dispersing effect of Zirconium and the conductivity-promoting effect of Ruthenium were further analyzed varying their fractions and noting the effect on the initial potential and the lifetime of the coating.

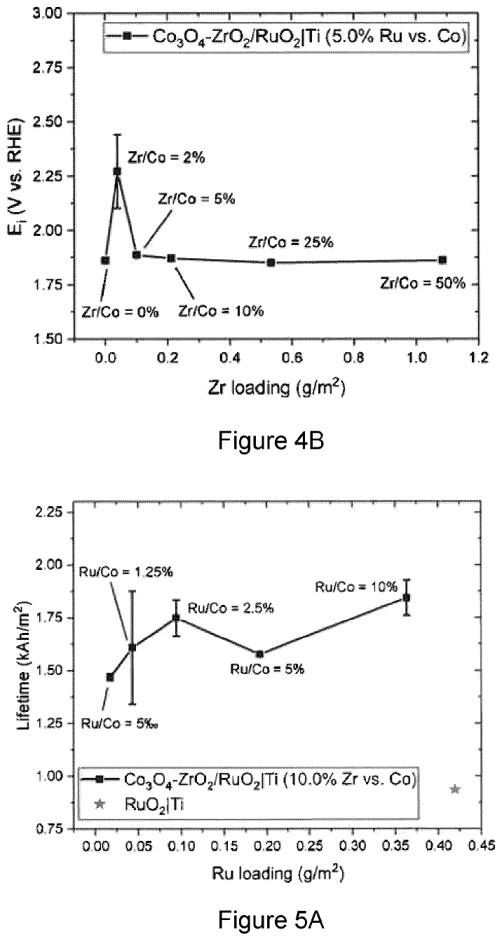

FIGS. 4a and 4b illustrate respectively the lifetime and the initial potentials of Cobalt oxide coatings with a fixed Cobalt/Ruthenium mass ratio and varying Zirconium mass fractions. In the examples of FIGS. 4a and 4b, the Cobalt/Ruthenium mass ratio equals 20. That means that the coating comprises for every gram of Cobalt 0.05 gram of Ruthenium. For the examples of FIGS. 4a and 4b, the Cobalt loading of the coating is approximately 2.1 g/m² for each sample. It is further noted that in the examples of FIGS. 4a and 4b, the coating is applied on a Titanium support.

FIG. 4a shows that the addition of Zirconium increases the lifetime, up until a Zirconium/Cobalt mass fraction of approximately 25%. A further increase of the Zirconium up to Zirconium/Cobalt mass fractions of 50%, show a decrease of the coating lifetime.

FIG. 4b shows that an increase of Zirconium above a mass fraction of approximately 5%, has no obvious positive effect on the initial potential, provided that in addition to the Zirconium, Ruthenium is present in the coating, as is the case in the example of FIG. 4b.

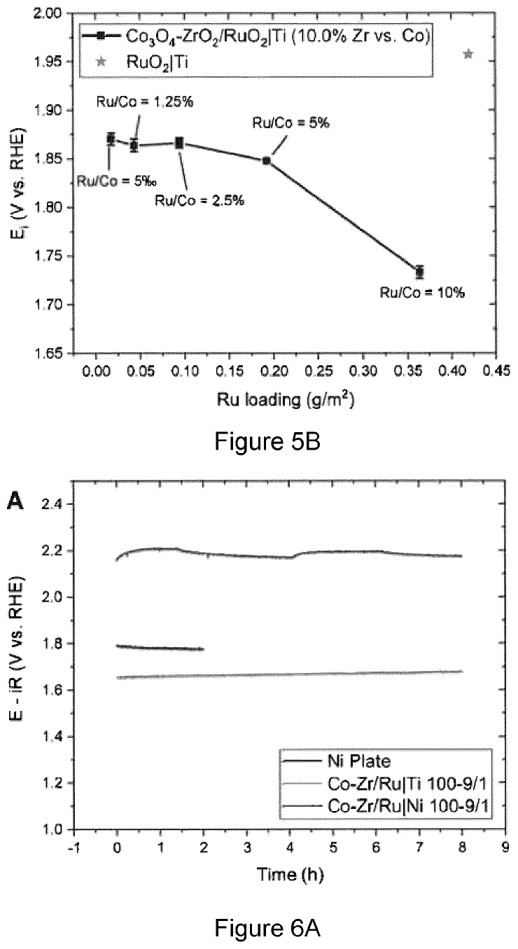

FIGS. 5a and 5b illustrate the relationship between the lifetime and initial potential of Cobalt oxide coatings with a fixed Cobalt/Zirconium ratio and an increasing Ruthenium loading. In the examples of FIGS. 5a and 5b, the Cobalt/Zirconium mass ratio equals 10, which means that there is 0.1 gram of Zirconium for each gram of Cobalt. It is further noted that for the examples of FIGS. 5a and 5b, the Cobalt loading is approximately 2.3 g/m². For the examples of FIGS. 4a and 4b, the coating is applied on a Titanium support.

FIG. 5a shows that the addition of Ruthenium above a minimum amount of 2.5% of the mass of Cobalt, does not importantly affect the lifetime of the coating. The reason for this is presumably the small amount of Ruthenium present in the coating compared to the amount of Cobalt.

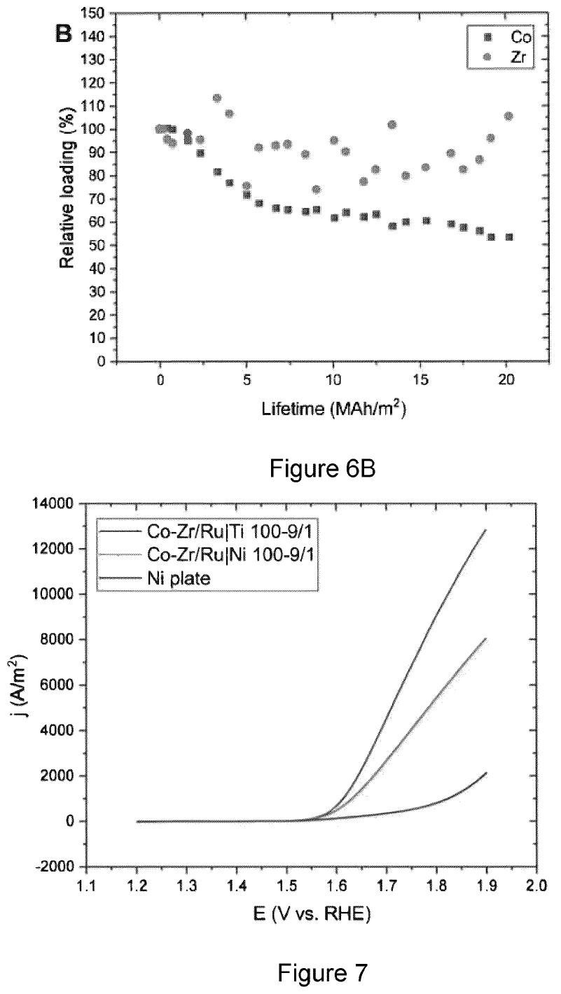

FIG. 5b shows that an increasing Ruthenium/Cobalt fraction leads to lower potentials. The reason for this phenomenon is presumably because RuO₂ (itself an efficient oxygen evolving catalyst) itself starts participating in the reaction. The beneficial effect in potential is already apparent at very small Ruthenium concentrations. A pure RuO₂ sample of comparable loading is shown as reference. FIG. 6a shows the results of short-term electrolysis experiments run at 10 kA/m² for a Nickel plate and respectively a Titanium support and a Nickel support comprising a Cobalt/Zirconium/Ruthenium coating with a mass ratio Cobalt/Zirconium that equals 10 and a Cobalt/Ruthenium mass ratio that equals 80. The Cobalt loading for the coating in FIG. 6a is approximately 3.5 gram/m². FIG. 6a shows that the supports with the Co/Zr/Ru coating have a lower (over) potential than pure Ni.

FIG. 6b show the relative wear rates of Cobalt and Zirconium measured on a Co/Zr/Ru coating on a Titanium support. The relevant Cobalt loading for FIG. 6b is approximately 10 gram/m².

The experiments shown in FIG. 6b were run in KOH 30% at a temperature of 50° C.

FIG. 7 shows the result of measurements in KOH 30% at a temperature of 20° C. with a Nickel plate and a Nickel support electrode and a Titanium support electrode both provided with a Co—Zr/Ru coating 100-9/1. These tests were limited to KOH 30% electrolyte due to the vulnerability of Nickel to acid. The Y-axis of FIG. 7 shows the electric current density.

The Co—Zr/Ru 100-9/1 coating show a clear activity enhancement for the Nickel support electrode when compared to pure Nickel, the benefit however is not as high as on the Titanium support electrode.

The difference in effectivity between the coating present on the Nickel support and on the Titanium support is presumably the fact that the Ruthenium component is less efficient at promoting the conductivity when the substrate is Nickel instead of Titanium. The short-term stability is sufficient for both substrates.

It is further noted that the data shown in FIG. 7 were recorded using cyclic voltammetry at a scan rate of 10 mVs⁻¹.

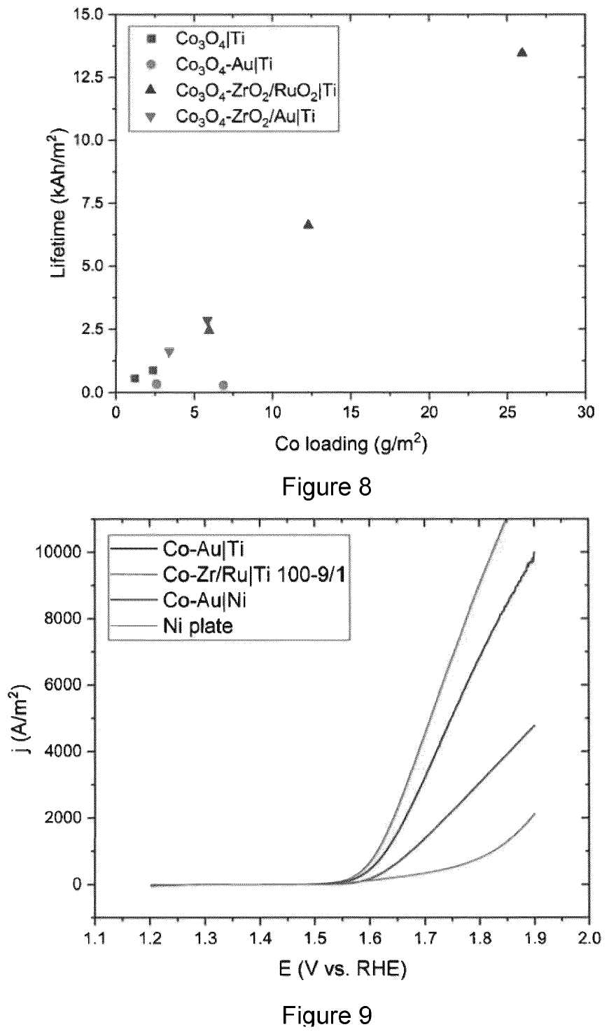

FIG. 8 represent the results of tests that were run to assess the effect of using a Cobalt oxide coating comprising Zirconium as dispersing agent and Gold (Au) to promote electrical conductivity throughout the bulk coating. On a Titanium support electrode, respectively, the efficiency of the lifetime enhancing effect of four different coatings was tested:
1) pure Cobalt oxide (CO₃O₄);
2) a Cobalt oxide coating comprising Gold (Co₃O₄-AU);
3) a Cobalt oxide coating comprising Zirconium and Gold (Co₃O₄—ZrO₂/Au); and
4) a Cobalt oxide coating comprising Zirconium and Ruthenium (Co₃O₄—ZrO₂/RuO₂)

According to the tests presented in FIG. 8, instead of using Ruthenium as a promoting agent, Gold was incorporated into the coating.

As shown in FIG. 8, it was found that the presence of Gold in the Cobalt oxide coating can have a beneficial effect on the lifetime of the coating, provided that the coating also comprises Zirconium as dispersing agent.

The coatings shown in FIG. 8 have a Cobalt/Gold mass ratio of 200.

The data provided for the Cobalt oxide coating comprising Zirconium and Ruthenium in FIG. 8 relate to a Co—ZR/RU 1100-9/1 electrode and these data are shown in FIG. 8 as a reference. The lifetime in the accelerated lifetime test in H₂SO₄ 25% was also improved relative to pure cobalt oxide, but only when ZrO₂ was also included. From characterization cyclic voltammograms, it appears that the inclusion of Gold promotes the electrical conductivity in the coating, similar to Ruthenium.

FIG. 9 represent the results of tests that were run to assess the effect of using a Cobalt oxide coating comprising Au in terms of activity. The effect of Au on the activity was also tested in KOH 30% electrolyte using cyclic voltammetry at 20° C. While Co—Au coatings offer higher activity than pure Nickel, the enhancement is not as large as for Co/Zr/Ru coatings.

1. An electrolyzer electrocatalyst, comprising Cobalt (Co) oxide, Zirconium (Zr), and a noble metal.

2. The electrolyzer electrocatalyst of claim 1, wherein the noble metal is selected from Ruthenium (Ru), Gold (Au), Iridium (Ir), Platinum (Pt), and Palladium (Pd).

3. The electrolyzer electrocatalyst of claim 1, wherein the noble metal is selected from Ruthenium (Ru) and Gold (Au).

4. The electrolyzer electrocatalyst of claim 1, wherein the mass fraction of Zirconium compared to Cobalt (Co) oxide is about 2%-20%.

5. The electrolyzer electrocatalyst of claim 1, wherein the mass fraction of the noble metal compared to Cobalt (Co) oxide is about 0.5%-20%.

6. The electrolyzer electrocatalyst of claim 1, wherein the electrocatalyst is one of an anode electrocatalyst or a cathode electrocatalyst.

7. An electrode for use in an electrolyzer, the electrode comprising a support and a coating, wherein the coating comprises Cobalt (Co) oxide, Zirconium (Zr), and a noble metal.

8. The electrode of claim 7, wherein the support comprises Nickel (Ni) or -Nickel alloys.

9. The electrode of claim 7, wherein the support comprises Titanium (Ti) or Titanium alloys.

10. The electrode of claim 7, wherein the support comprises steel or stainless steel.

11. The electrode of claim 7, wherein the noble metal is selected from Ruthenium (Ru) and Gold (Au).

12. The electrode claim 7, wherein the mass fraction of Zirconium compared to Cobalt (Co) oxide is about 2%-20%.

13. The electrode of claim 7, wherein the mass fraction of the noble metal compared to Cobalt (Co) oxide is about 0.5%-20%.

14. The electrode of claim 7, wherein the Cobalt (Co) loading in the coating is about 2-25 g/m².

15-22. (canceled)

23. A method for producing an electrode for use in an electrolyzer, the electrode comprising a support and a coating, the method comprising the steps of:
preparing a metal support comprising Nickel (Ni) or Titanium (Ti),
applying on the support a coating comprising Cobalt (Co) oxide, Zirconium (Zr), and a noble metal, and
heating the support comprising the coating in air.

24. The method of claim 23, wherein the step of applying on a support a coating comprising Cobalt (Co) oxide, Zirconium (Zr) and a noble metal comprises:
applying the coating by painting water-based solutions of the metal salt precursors comprising Cobalt (Co) oxide, Zirconium (Zr), and a noble metal onto the support.

25. The method of claim 23, wherein the method further comprises:
prior to applying the coating, adding a viscosity modifier, wherein the viscosity modifier is polyethylene glycol.

26. The method of claim 23, wherein the method further comprises:
heating the support and the coating at a temperature between 300° C. and 600° C.

27. The method of claim 23, wherein the step of applying the coating on the support is preceded by the step:
etching the support with hydrochloric acid (HCL).
